(19) United States
(12) Patent Application Publication
(10) Pub. No.: US 2026/0201863 A1
(43) Pub. Date: Jul. 16, 2026

(54) WIND TURBINE BLADE

(71) Applicant: Vestas Wind Systems A/S, Aarhus N. (DK)

(72) Inventor: Gurmukh Singh, Skiern (DK)

(73) Assignee: Vestas Wind Systems A/S, Aarhus N. (DK)

(21) Appl. No.: 19/138,202

(22) PCT Filed: Dec. 14, 2023
(86) PCT No.: PCT/DK2023/050312

§ 371 Date: Jun. 12, 2025

(30) Foreign Application Priority Data
Dec. 15, 2022 (DK) 202270612

(51) Int. Cl. F03D 1/06

(52) U.S. Cl. CPC F03D 1/0682

(57) ABSTRACT

According to the present invention there is provided a wind turbine blade comprising a blade shell that extends longitudinally in a spanwise direction from a root end to a tip end, and transversely in a chordwise direction between a leading edge and a trailing edge. The blade shell is formed from first and second opposing half shells of composite laminate construction. Each half shell comprises an inner skin on an inside of the blade shell and an outer skin on an outside of the blade shell. The blade further comprises a first spar cap located between the inner and outer skins of the first half shell and a second spar cap located between the inner and outer skins of the second half shell. The first and second spar caps are mutually opposed. The first spar cap comprises a plurality of side-by-side stacks of longitudinally-extending strips of reinforcing material, the stacks including at least one web-supporting stack and at least one non-web-supporting stack. The blade further comprises a shear web connected between the first and second spar caps. The shear web comprises a longitudinally-extending web panel and first and second mounting flanges, the first and second mounting flanges extending transversely to the web panel along respective longitudinal edges of the web panel. The first mounting flange is adhesively bonded to the inside of the first half shell in the region of the web-supporting stack(s) of the first spar cap and the second mounting flange is adhesively bonded to the inside of the second half shell in the region of the second spar cap. At a first spanwise location along the blade, the number of strips in a web-supporting stack of the first spar cap is different to the number of strips in a non-web-supporting stack of the first spar cap.

### TECHNICAL FIELD

The present invention relates generally to wind turbine blades and more specifically to a wind turbine blade comprising a shear web and a pair of mutually-opposed spar caps.

### BACKGROUND

There is a continuing desire to generate increased levels of power from onshore and offshore wind farms. One way to achieve this is to provide modern wind turbines with larger wind turbine blades. The provision of larger blades increases the swept area of the wind turbine rotor, allowing the turbine to capture more energy from the wind. However, larger wind turbine blades typically experience increased loading during transport and in use, in part due to the increased weight of the blade. As such, the size of a wind turbine blade typically affects the requirements for structurally reinforcing the blade.

For example, a wind turbine blade may comprise an outer shell supported by a longitudinally-extending spar structure that includes a shear web arranged between two mutually-opposed spar caps. Longer blades typically comprise longer spar caps, and such spar caps may also be thicker and/or comprise more reinforcing material to safely absorb and transfer the increased bending loads experienced by such larger blades in use. However, increasing the amount of reinforcing material in a blade typically increases both the cost and the weight of the blade.

The rated power of a wind turbine, or the wind class in which the turbine operates, may be another factor that influences the structural reinforcement requirements for a wind turbine blade designed for a particular turbine. For example, blades for wind turbines with a higher rated power may require more structural reinforcement than blades designed for wind turbines having a lower rated power. Accordingly, structural reinforcement requirements may also vary between wind turbine blades independent of blade length.

To reduce both the cost and weight of a wind turbine blade it is advantageous to minimise the amount of reinforcing material used to manufacture wind turbine blades where possible, whilst still maintaining the requisite structural reinforcement. It is against this background that the present invention has been developed.

### SUMMARY

According to a first aspect of the present invention there is provided a wind turbine blade comprising a blade shell that extends longitudinally in a spanwise direction from a root end to a tip end, and transversely in a chordwise direction between a leading edge and a trailing edge. The blade shell is formed from first and second opposing half shells of composite laminate construction. Each half shell comprises an inner skin on an inside of the blade shell and an outer skin on an outside of the blade shell. The blade further comprises a first spar cap located between the inner and outer skins of the first half shell and a second spar cap located between the inner and outer skins of the second half shell. The first and second spar caps are mutually opposed. The first spar cap comprises a plurality of side-by-side stacks of longitudinally-extending strips of reinforcing material. The stacks include at least one web-supporting stack and at least one non-web-supporting stack. The blade further comprises a shear web connected between the first and second spar caps. The shear web comprises a longitudinally-extending web panel and first and second mounting flanges. The first and second mounting flanges extend transversely to the web panel along respective longitudinal edges of the web panel. The first mounting flange is adhesively bonded to the inside of the first half shell in the region of the web-supporting stack(s) of the first spar cap and the second mounting flange is adhesively bonded to the inside of the second half shell in the region of the second spar cap. At a first spanwise location along the blade, the number of strips in a web-supporting stack of the first spar cap is different to the number of strips in a non-web-supporting stack of the first spar cap.

The spar cap configuration advantageously facilitates a tailored arrangement of reinforcing material in the wind turbine blade. For example, the arrangement of the strips of reinforcing material may be tailored to the structural reinforcement requirements of one or more specific portions of the blade. In particular, the provision of reinforcing material in web-supporting and non-web-supporting stacks facilitates a more tailored arrangement of strips than would otherwise be possible. The reinforcing material, i.e. strips of reinforcing material in each stack, can be individually arranged in accordance with the structural reinforcement requirements of a particular spanwise portion of the blade. For example, the arrangement of reinforcing material in the first spar cap can be tailored in both the spanwise and chordwise directions by individually varying the number, and spanwise position, of strips in each stack in isolation. As such, the wind turbine blade, and in particular the spar cap thereof, facilitates greater freedom for the arrangement of reinforcing material in the blade such that the blade comprises the requisite amount of reinforcing material where required, without unnecessarily including additional reinforcing material where it is not required.

It will be appreciated that the comparison between the web-supporting stacks and the non-web-supporting stacks is made when the wind turbine blade is viewed in transverse cross-section at the spanwise location, i.e. in a plane perpendicular to the spanwise direction. The primary function of a web-supporting stack is to support the shear web and receive loads transferred from the shear web to the spar cap. For example, the or each stack having at least part of the stack inside a footprint of the shear web panel is a web-supporting stack. In some examples, the blade may additionally comprise one or more other stacks within a footprint of the shear web mounting flanges. Such stacks may also receive a substantial proportion of the loads transferred from the shear web to the spar cap via the mounting flanges and, as such, may be referred to as web-supporting stacks in some examples.

Conversely, the primary function of a non-web-supporting stack is to provide structural reinforcement to the wind turbine blade, to absorb longitudinal bending loads experienced by the blade shell in use. Any stack outside the footprint of the web mounting flanges is a non-web-supporting stack. In some examples, a peripheral region of a shear web mounting flange may extend over a peripheral portion of a stack. It will be appreciated that in such an example, it cannot be said that the primary function of the stack is to support the shear web and receive loads transferred from the shear web to the spar cap. Such a stack may therefore also be referred to as a non-web-supporting stack.

In some examples the first spar cap may extend over a greater spanwise length than the shear web. As such, a portion of the spar cap may extend beyond the shear web. It will be appreciated that portions of a stack extending beyond the shear web may still be referred to as web-supporting stacks if such a stack supports the shear web, in line with the description above, at some point along the length of the stack.

The reinforcing material may comprise fibre reinforced plastic, such as carbon fibre reinforced plastic (CFRP), for example. In some examples the strips of reinforcing material may be formed in a pultrusion process and may therefore be referred to as pultrusions. In preferred examples the strips of reinforcing material may comprise CFRP pultrusions.

In some examples, the strips of reinforcing material may have substantially the same height. That is to say, the individual strips of reinforcing material in the or each web-supporting stack may each have the same height as the individual strips of reinforcing material in the or each non-web-supporting stack. In some preferred examples, all of the strips in the first spar cap may be substantially the same except for their respective spanwise lengths. For example, the strips may be pultrusions and may therefore have a substantially identical composition and substantially identical width and height dimensions. This means that all of the strips can be manufactured in the same pultrusion process, with the strips being cut to the required length in a simple operation.

In some examples, at the first spanwise location, a height of a web-supporting stack of the first spar cap may be different to a height of a non-web-supporting stack. The difference in height between the web-supporting and non-web-supporting stacks at the first spanwise location may result from the different number of strips in each stack at the first spanwise location.

In some examples, at the first spanwise location, a web-supporting stack of the first spar cap may include a greater number of strips than a non-web-supporting stack. Accordingly, the height of a web-supporting stack of the first spar cap may be greater than the height of a non-web-supporting stack. Further, each web-supporting-stack of the first spar cap may comprise a greater quantity of reinforcing material than each non-web-supporting stack of the first spar cap. For example, the quantity of reinforcing material may be measured by weight.

In some other examples, at the first spanwise location, a web-supporting stack of the first spar cap may include fewer strips than a non-web-supporting stack. Accordingly, the height of a web-supporting stack of the first spar cap may be less than the height of a non-web-supporting stack. Further, each web-supporting-stack of the first spar cap may comprise a lower quantity of reinforcing material than each non-web-supporting stack of the first spar cap.

In some examples, at a second spanwise location along the blade, the number of strips in a web-supporting stack of the first spar cap may be the same as the number of strips in a non-web-supporting stack. Here the number of strips may be tailored to the structural reinforcement requirements of specific portions of the blade. This configuration allows for the arrangement of more strips in the areas requiring additional reinforcement, without unnecessarily including strips where they are not required, thereby helping to minimise weight and cost of the blade. In particular, tailoring the number of strips in each stack, rather than across the whole width of the spar cap, i.e. by varying the number of strips in the web-supporting stacks and non-web-supporting stacks relative to one another at the first and second spanwise locations, facilitates finer adjustment of the amount, and location, of the reinforcing material in the blade. At the second spanwise location, the number of strips in a web-supporting stack of the first spar cap may be the same as the number of strips in a non-web-supporting stack so as to provide the maximum amount of reinforcement material within a given cross-section area of the spar cap.

In preferred examples, the first spar cap may have a greater thickness at the first spanwise location than at the second spanwise location. In some examples, the first spanwise location may be in a central portion of the blade. The second spanwise location may be between the root end of the blade and the central portion. In some examples the second spanwise location may be at a root end of the spar cap. Additionally or alternatively, the second spanwise location may be between the tip end of the blade and the central portion. In some examples the second spanwise location may be at a tip end of the spar cap. It will be appreciated that as used herein the root end of the spar cap refers to that end of the spar cap which is closest to the root end of the blade, and the tip end of the spar cap refers to that end of the spar cap which is closest to the tip end of the blade.

In the central portion of the blade, the shear web is connected between the first and second spar caps. In this central region it is possible to tailor the amount of reinforcing material in the spar cap without having an impact on the web height between the first and second spar caps by varying the number of strips in a non-web-supporting stack. At the second spanwise location, outside of the central portion of the blade, the shear web may not be present so the number of strips in a web-supporting stack may be the same as the number of strips in a non-web-supporting stack.

In some examples, the central portion may have a spanwise extent of between 10-40% of the overall length of the first spar cap, and preferably between 10-30% and more preferably between 10-20% of the overall length of the first spar cap. In some examples, the central portion of the blade may be spaced at least 0.1 L, preferably at least 0.2 L, more preferably at least 0.3 L from the root end of the blade, where L represents the total length of the blade.

In some examples, the first spanwise location may be located a distance of at least 0.1 L, preferably at least 0.2 L, more preferably at least 0.3 L from the root end of the blade in the spanwise direction, where L represents the total length of the blade.

In some examples, the first spar cap may have a maximum thickness throughout the central portion of the blade. The first spar cap may additionally taper in thickness outside of the central portion. For example, the first spar cap may taper in thickness towards the root end of the blade. Accordingly the first spar cap may comprise a tapered root end portion. In some examples the tapered root end portion may comprise the second spanwise location. Additionally or alternatively the first spar cap may taper in thickness towards the tip end of the blade. Accordingly the first spar cap may comprise a tapered tip end portion. In some examples the tapered tip end portion may comprise the second spanwise location.

In some examples the first spar cap may have a substantially constant thickness across its full width in the chordwise direction at the second spanwise location. Conversely, in some examples, the first spar cap may vary in thickness across its full width in the chordwise direction at the first spanwise location. In preferred examples, the first spar cap may vary in thickness across its full width in the chordwise direction throughout the central portion of the blade. In other words, the or each web-supporting stack may be a different height compared to the or each non-web-supporting stack throughout the central portion of the blade.

In some examples, the first spar cap may comprise tapered strips of reinforcing material. For example, one or more strips of reinforcing material in the spar cap may taper in thickness towards its tip end. Additionally or alternatively, one or more strips of reinforcing material may taper in thickness towards its root end. In preferred examples, each strip of reinforcing material may taper in thickness towards its respective root end and tip end. Accordingly, in examples wherein the first spar cap tapers in thickness, the tapered ends of the strips of reinforcing material may help to form a gradually tapering spar cap, i.e. tapering in a smooth manner and not a step-wise manner. It will be appreciated that a root end or a tip end of a strip of reinforcing material is used herein to refer to that end of a strip which is closest to the root end of the blade, or closest to the tip end of the blade, respectively.

In some examples, the strips forming the first spar cap may be arranged in a plurality of layers. Further, in some examples the number of strips in an outermost layer adjacent the outer skin may be greater than the number of strips in an innermost layer.

The spar cap may taper in thickness moving in the spanwise direction towards the root end of the blade and/or towards the tip end of the blade. In other words, the spar cap may taper in thickness at one or both of its ends. This tapering may be achieved by arranging the strips such that their root and tip ends terminate at different spanwise locations along the blade. For example, the outermost strip in a stack may have the greatest length, and the strips may become progressively shorter through the thickness of the spar cap moving towards the innermost layer. The or each strip in the innermost layer of the spar cap may have the shortest spanwise length.

Accordingly, in preferred examples, the strip(s) in the innermost layer may be shorter than the strips in the outermost layers. In some examples, the strips in the outermost layer may be at least as long as the strips in each other layer. In preferred examples, the strips in the outermost layer may be longer than the strips in each other layer.

In some examples, the innermost layer of strips in the first spar cap may consist exclusively of strips within web-supporting stacks. Alternatively, the innermost layer of strips in the first spar cap may consist exclusively of strips within non-web-supporting stacks, in some examples.

In some examples, each layer of the first spar cap may include the same number of strips except for one or more innermost layers, which may include fewer strips. Those strips may be exclusively within web-supporting stacks or exclusively within non-web-supporting stacks.

Each strip in the outermost layer may comprise an outwards-facing surface, i.e. a surface facing the outer skin. Further, each web-supporting stack and each non-web-supporting stack may comprise an outwards-facing surface defined by the strips in the outermost layer. In preferred examples, the outwards-facing surface of a stack may be defined by a single strip. For example, the outermost strip of each stack preferably extends along, and thereby defines, the total spanwise length of a respective stack.

In some examples, the outermost strip in each stack in the first spar cap may be substantially the same. In preferred examples, the outermost strip in each stack may be substantially flush with the outermost strip in each adjacent stack such that the outwards-facing surfaces of each stack are substantially flush with one another.

It will be appreciated that each stack comprises one or more innermost strips of reinforcing material. The or each innermost strip of each stack defines an inwards-facing surface of the respective stack. In preferred examples, the inwards facing surface of each stack is defined by a single innermost strip of the respective stack. It will be appreciated that, due to the difference in number of strips in the web-supporting and non-web-supporting stacks, the innermost strips of the stacks may form different layers of the spar cap. As such, the innermost strips of the stacks may not be flush with one another, and the inwards-facing surfaces of each stack may not be flush with one another.

In some examples, the first spar cap may comprise a filler material configured to smoothen the transition between adjacent stacks of different heights. In some examples the filler material may comprise a rope of unidirectional fibres. In some other examples, the filler material may comprise wadding, such as cotton wool or fleece material. The filler material advantageously prevents the formation of a resin rich area in portions of the spar cap where there is a difference in height between adjacent stacks.

In some examples, the first spar cap may include one or more web-supporting stacks defining a chordwise centre of the first spar cap; one or more first non-web-supporting stacks on a leading-edge side of the web-supporting stack(s); and one or more second non-web-supporting stacks on a trailing-edge side of the web-supporting stack(s). In some such examples the non-web-supporting stacks of the first spar cap may define longitudinal edges of the first spar cap.

In some other examples, the first spar cap may include one or more first web-supporting stacks supporting a first shear web, one or more second web-supporting stacks supporting a second shear web, and one or more non-web-supporting stacks arranged between the first and second web-supporting stacks. In some of such examples the web-supporting-stacks of the first spar cap may define longitudinal edges of the first spar cap.

In some examples the first and second mounting flanges of the shear web may be wider than the web panel in the chordwise direction. Preferably, the mounting flanges may be significantly wider than the web panel in the chordwise direction. This provides stability to the shear web, and also provides a relatively large surface area for bonding the shear web to the blade shell.

In some examples, the first and second mounting flanges may each extend transversely to the web panel on a single side of the web panel. For example, the first and second mounting flanges may both extend transversely to the web panel on the same side of the web panel such that the shear web is substantially C-shaped in cross section. Alternatively, the first and second mounting flanges may each extend transversely to the web panel on different sides of the web panel such that the shear web is substantially Z-shaped in cross section.

In preferred examples, the first and second mounting flanges may each extend transversely to the web panel on both a first side and a second side of the web panel such that the shear web resembles an I-beam, i.e. the shear web may be substantially I-shaped in cross section. This may help with distributing loads in the mounting flanges and transferring loads safely between the spar caps and the shear web panel in use. The mounting flanges preferably extend substantially the same chordwise distance from the web panel on both the first and second sides of the web panel such that the web panel is located in the middle of the shear web when viewed in transverse cross section.

In preferred examples, the shear web may be aligned substantially centrally in relation to the or each web-supporting stack which supports that particular shear web. In other words, when viewed in transverse cross section, the shear web panel is preferably substantially aligned with a chordwise midpoint of the or each web-supporting stack. This helps to maintain an even load distribution through the mounting flange and across the or each web-supporting stack.

In some examples, the shear web may be supported by a single web-supporting stack of the first spar cap. In such an example, the strips of reinforcing material preferably have a chordwise width that is at least equal to the chordwise width of the first mounting flange of the shear web. More preferably, the strips of reinforcing material in such an example may have a chordwise width that is greater than the chordwise width of the first mounting flange. In some examples the strips of reinforcing material may be substantially rectangular in cross-sectional profile. In other words, the strips of reinforcing material may be substantially rectangular when the wind turbine blade is viewed in transverse cross-section at the spanwise location, i.e. in a plane perpendicular to the spanwise direction. This is advantageous for accurate alignment and positioning of the strips when manufacturing the wind turbine blade.

In some examples the strips of reinforcing material may have an aspect ratio of at least 10:1, and preferably at least 20:1. The aspect ratio may be defined as the ratio of the width of the strips in the chordwise direction to the thickness of the strips. In some preferred examples, the strips may have a width of approximately 100 mm and a thickness of approximately 5 mm, thus providing an aspect ratio of 20:1, or in some examples the strip width may be approximately 200 mm, providing an aspect ratio of 40:1. The strips have a great length perpendicular to their width and thickness. Preferably at least the outermost strips of each stack extends the full length of the spar cap, or at least a majority of the length of the spar cap.

According to a second aspect of the present invention there is provided a family of wind turbine blades of substantially equal length and of substantially the same external shape. Each blade comprises a blade shell that extends longitudinally in a spanwise direction from a root end to a tip end and transversely in a chordwise direction between a leading edge and a trailing edge. The blade shell is formed from first and second opposing half shells. Each blade further comprises a first spar cap associated with the first half shell and a second spar cap associated with the second half shell. The first and second spar caps are mutually opposed. The first spar cap comprises a plurality of side-by-side stacks of longitudinally-extending strips of reinforcing material, the stacks including at least one web-supporting stack and at least one non-web-supporting stack. Each blade further comprises a shear web connected between the first and second spar caps. The family of wind turbine blades comprises a first blade designed for a first wind turbine operating in a first wind class or having a first rated power, and a second blade designed for a second wind turbine operating in a second wind class or having a second rated power. The second wind class or second rated power is different to the first wind class or first rated power. At a first spanwise location along the blade, the number of strips in a non-web-supporting stack of the first spar cap of the first blade is different to the number of strips in a corresponding non-web-supporting stack of the first spar cap of the second blade.

The first and second blades in the family are of equal length and of substantially the same external shape. As such, the first and second blades may be manufactured using the same apparatus. For example, corresponding first half shells of each blade in the family may be manufactured in the same shell mould. Similarly, corresponding second half shells of each blade in the family may be manufactured in the same mould. Significant reductions in manufacturing cost are therefore possible by facilitating reuse of the same mould to form different wind turbine blades for different turbines operating in different wind classes or having a different rated power. Additionally, using the same moulding apparatus to form different blades significantly reduces factory floor space usage in a blade manufacturing facility because fewer moulds are required for forming the different blades.

In particularly preferred examples, the first and second blades in the family may be substantially the same except for the configuration of their respective corresponding spar caps. For example, whilst the first and second blades are of equal length and of substantially the same external shape, i.e. having substantially identical external geometry, in preferred examples internal components of the first and second blade (except the corresponding spar caps) may also be the same, as described later in more detail. Sharing components across the different blades in the family may further reduce manufacturing costs due to economies of scale and reduce engineering effort in designing different components for different blades.

It should be understood that as used herein the term “corresponding” is used to refer to components of each blade in the family that serve the same function as one another and which are located in an equivalent location in each blade in the family. For example, a non-web-supporting stack of the first spar cap of the first blade and a corresponding non-web-supporting stack of the first spar cap of the second blade may be located in substantially the same position within the respective first and second blades, and within the respective first spar caps. It will be appreciated that this is provided by way of example only to demonstrate one example of many possible “corresponding” components of each blade in the family.

In some examples, the first blade in the family of wind turbine blades may be a blade as described previously in accordance with examples of the first aspect of the invention. Additionally or alternatively, the second blade in the family of wind turbine blades may be a blade as described previously in accordance with examples of the first aspect of the invention.

In some examples, the non-web-supporting stack of the first spar cap of the first blade may comprise a different quantity of reinforcing material compared to the corresponding non-web-supporting stack of the first spar cap of the second blade. In other words, the non-web-supporting stack of the first blade may comprise a first quantity of reinforcing material, and the corresponding non-web-supporting stack of the second blade may comprise a second quantity of reinforcing material that is different to the first quantity.

For example, the non-web-supporting stack of the first spar cap of the first blade may comprise a first mass of reinforcing material and the corresponding non-web-supporting stack of the first spar cap of the second blade may comprise a second mass of reinforcing material that is different to the first mass. As such, the non-web-supporting stack of the first spar cap of the first blade may have more or less reinforcing material by weight than the corresponding non-web-supporting stack of the first spar cap of the second blade.

The stacks of strips of reinforcing material are preferably arranged side-by-side in the chordwise direction, i.e. each stack is preferably adjacent to at least one other stack in the chordwise direction.

In some preferred examples, the corresponding first spar caps of the first and second wind turbine blades may be the same width in the chordwise direction along the length of the spar caps. Advantageously this may mean that there are no fundamental changes in design between the blades in the family. For example the blade shell of each blade may comprise core panels arranged on each side of the first spar cap. Maintaining the width dimension of the first spar cap across different blades in the family means that the same core panels can be used to manufacture the blade shells of different blades in the family. It follows that in some examples, the first spar cap of the first blade may comprise the same number of side-by-side stacks as the first spar cap of the second blade. Further, the strips in each stack of the first spar cap of the first blade may be substantially the same width and thickness as the strips in each corresponding stack of the first spar cap of the second blade. Accordingly, the corresponding first spar caps of the first and second wind turbine blades may be the same width in the chordwise direction.

In some examples, the first blade may be designed for a first wind turbine operating in a higher wind class or having a higher rated power than the wind class or rated power of the second wind turbine for which the second blade is designed. At the first spanwise location, the number of strips in a non-web-supporting stack of the first spar cap of the first blade may be greater than the number of strips in a corresponding non-web-supporting stack of the first spar cap of the second blade in such an example.

Wind classes are defined by the International Electrotechnical Commission (IEC) in IEC 61400. For example the first blade may be designed to operate in Wind Class I (high wind) and the second blade may be designed to operate in Wind Class III (low wind). In the context of the present disclosure the term “higher” when referring to a wind class means a stronger wind class, i.e. Wind Class I is higher than Wind Class II.

The rated power of a wind turbine is defined in IEC 61400 as the maximum continuous electrical power output which a wind turbine is designed to achieve under normal operating and external conditions. Large commercial wind turbines are generally designed for a lifetime of 20 to 30 years and their rated power output takes into account that lifespan. For example, the first blade may be designed for a wind turbine with a rated power of 6 MW and the second blade may be designed for a wind turbine with a rated power of 4 MW.

In some examples, each strip of reinforcing material in the first spar cap of each blade may have the same thickness. As such, the difference in the number of strips in the corresponding non-web-supporting stacks of the first spar caps of the first and second blades may result in a difference in the height of said stacks.

In some examples, at the first spanwise location, a height of the or each non-web-supporting stack of the first spar cap of the first blade may be different to a height of the or each corresponding non-web-supporting stack of the first spar cap of the second blade. In some examples, at the first spanwise location a height of the or each non-web-supporting stack of the first spar cap of the first blade may be greater than a height of the or each corresponding non-web-supporting stack of the first spar cap of the second blade. In some examples, at the first spanwise location along the blade, the number of strips in the or each web-supporting stack of the first spar cap of the first or second blade in the family may be different to the number of strips in the or each non-web-supporting stack of the first spar cap of that blade.

In some examples, the second spar cap of each blade may comprise a plurality of side-by-side stacks of longitudinally-extending strips of reinforcing material. The stacks of the second spar cap may include at least one web-supporting stack and at least one non-web-supporting stack.

In some examples, the shear web of each blade may be connected between one or more web-supporting stacks of the mutually-opposed first and second spar caps. Along the length of the first and second spar caps, a separation between the web-supporting stacks of the first and second spar caps of the first blade is preferably substantially the same as a separation between the web-supporting stacks of the first and second spar caps of the second blade.

In some preferred examples, along at least a portion of the length of the spar caps, a separation between the non-web-supporting stacks of the first and second spar caps of the first blade may be different to a separation between corresponding non-web-supporting stacks of the first and second spar caps of the second blade.

In some examples, the or each web-supporting stack of the first spar cap of the first blade may be substantially the same as the or each corresponding web-supporting stack of the first spar cap of the second blade. This facilitates an increase in efficiency of design, manufacture and assembly of blades in the family by reducing the variation between parts of different blades in the family.

In some examples, the shear web of the first blade may be substantially the same as the shear web of the second blade. For example, the shear web of the first blade may be substantially the same height as the shear web of the second blade. In particularly advantageous examples, the use of substantially the same shear web in the first and second blades may be facilitated, at least in part, by the previously-described separation between the web-supporting stacks of the first and second spar caps of the first blade being substantially the same as the separation between the web-supporting stacks of the first and second spar caps of the second blade.

A family of blades each comprising the same shear web is particularly advantageous for reducing the cost of designing and manufacturing different blades in the family. Typically, a shear web may be specific to a particular blade for a turbine in a particular wind class or having a particular rated power. Manufacturing blades for different turbines therefore typically requires additional engineering effort and tooling for manufacturing the different shear webs. By using the same shear web in different blades in the family of wind turbine blades, the costs for designing and tooling to manufacture the shear webs in the family is limited to a single shear web design.

At a second spanwise location along the blade, the number of strips in the or each non-web-supporting stack of the first spar cap of the first blade may be the same as the number of strips in the or each corresponding non-web-supporting stack of the first spar cap of the second blade.

In some examples, the first spanwise location may be in a central portion of the blade and the second spanwise location may be between the root end of the blade and the central portion. Additionally or alternatively, the second spanwise location may be between the tip end of the blade and the central portion.

In some examples, for each blade in the family the central portion may have a spanwise extent of between 10-40% of the overall length of the first spar cap, and preferably between 10-30% and more preferably between 10-20% of the overall length of the first spar cap. Further, in some examples, the central portion of each blade in the family may be spaced at least 0.1 L, preferably at least 0.2 L, more preferably at least 0.3 L from the root end of the blade, where L represents the total length of the blade.

In some examples, the first spanwise location of each blade in the family may be located a distance of at least 0.1 L, preferably at least 0.2 L, more preferably at least 0.3 L from the root end of the blade in the spanwise direction, where L represents the total length of the blade.

In some examples, throughout the central portion, the height of the or each non-web-supporting stack of the first spar cap of the first blade may be different to the height of the or each corresponding non-web-supporting stack of the first spar cap of the second blade. In some examples, excluding the central portion, the or each non-web-supporting stack of the first spar cap of the first blade may be the same as the non-web-supporting stack of the first spar cap of the second blade.

In some examples, for both the first blade and the second blade, each stack of the first spar cap may taper from a respective portion of maximum height towards both a root end of the stack and a tip end of the stack. In some examples, the portion of maximum height of the or each non-web-supporting stack of the first blade may be offset in the spanwise direction in comparison to the portion of maximum height of the or each non-web-supporting stack of the second blade.

In some examples, the first spar cap of each blade in the family may include one or more web-supporting stacks defining a chordwise centre of the first spar cap. Additionally, the first spar cap may include one or more first non-web-supporting stacks on a leading-edge side of the web-supporting stack(s), and one or more second non-web-supporting stacks on a trailing-edge side of the web-supporting stack(s). As such, the web-supporting stack(s) may be sandwiched between a pair of non-web-supporting stacks in the chordwise direction. In such examples, the non-web-supporting stacks of the first spar cap of each blade may define longitudinal edges of the respective spar cap.

In some other examples, the first spar cap of each blade in the family may include one or more first web-supporting stacks supporting a first shear web and one or more second web-supporting stacks supporting a second shear web. The first spar cap of each blade may further comprise one or more non-web-supporting stacks arranged between the first and second web-supporting stacks. In such an example, the web-supporting-stacks of the first spar cap of each blade may define the longitudinal edges of the first spar cap.

In some examples, the shear web of each blade in the family may comprise a longitudinally-extending web panel and first and second mounting flanges, the first and second mounting flanges extending transversely to the web panel along respective longitudinal edges of the web panel. The first and second mounting flanges of each shear web are preferably wider than the web panel in the chordwise direction.

In some examples, for each blade in the family, the first mounting flange of the shear web may be adhesively bonded to an inner surface of the first half shell in the region of the web-supporting stack(s) of the first spar cap. Further, the second mounting flange of the shear web may be adhesively bonded to an inner surface of the second half shell in the region of the second spar cap. For example, the second mounting flange of the shear web may be adhesively bonded to an inner surface of the second half shell in the region of the web-supporting stack(s) of the second spar cap.

For each blade, the first and second mounting flanges of the shear web may each extend transversely to the web panel on both a first side of the web panel and a second side of the web panel. As such, in preferred examples the shear web of each blade may resemble an I-beam, i.e. the shear web may be substantially I-shaped in cross section.

In preferred examples, the first and second half shells of each blade in the family may be of composite laminate construction. As such, each half shell may comprise an inner skin on an inside of the blade shell and an outer skin on an outside of the blade shell. In such examples, the first spar cap of each blade may be located between the inner and outer skins of the first half shell and the second spar cap of each blade may be located between the inner and outer skins of the second half shell.

It will be appreciated that the second spar cap of each blade in the family may be substantially similar to the first spar cap. As such, it will be appreciated that features described with reference to the first spar cap of each blade may be equally applicable to the second spar cap of each blade in some examples. Notably, the first and second spar caps of a blade may not necessarily be configured in an identical manner, i.e. the stacks of strips may be arranged differently, and may comprise different numbers of strips, for the first and second spar caps of a blade in the family. Further, it will be appreciated that the different spar cap configurations, i.e. different arrangements of strips, described by way of example with reference to the first aspect of the invention may be equally applicable to the spar caps of the blades in the family of wind turbine blades in the second aspect of the invention in some examples.

### BRIEF DESCRIPTION OF THE DRAWINGS

Examples of the present invention will now be described by way of non-limiting example only, with reference to the accompanying figures, in which:

FIG. 1 is a schematic exploded view of a wind turbine blade;

FIG. 2 is a schematic plan view of a wind turbine blade;

FIG. 3a is a schematic cross-sectional view of a wind turbine blade taken at a first spanwise location showing a first spar cap comprising a plurality of side-by-side stacks of strips of reinforcing material;

FIG. 3b is a schematic cross-sectional view of a wind turbine blade taken at a second spanwise location;

FIG. 4a is a side view of a web-supporting stack of strips of the first spar cap;

FIG. 4b is a side view of a non-web-supporting stack of strips of the first spar cap;

FIGS. 5a and 5b are schematic cross-sectional views of another example of a wind turbine blade taken at the first spanwise location and the second spanwise location respectively;

FIG. 6 is a schematic plan view of a family of wind turbine blades of substantially equal length and of substantially the same external shape;

FIG. 7a is a schematic cross-sectional view of a first blade in the family taken at the first spanwise location along the first blade;

FIG. 7b is a schematic cross-sectional view of a second blade in the family taken at the first spanwise location along the second blade;

FIG. 7c is a schematic cross-sectional view showing cross sections taken at the second spanwise location of both the first blade and the second blade;

FIG. 8a is a side view of a non-web-supporting stack of strips of a first spar cap of the first blade;

FIG. 8b is a side view of a corresponding non-web-supporting stack of strips of a first spar cap of the second blade; and

FIG. 8c is a side view of a web-supporting stack of strips of the first spar cap of the first blade and the second blade.

### DETAILED DESCRIPTION

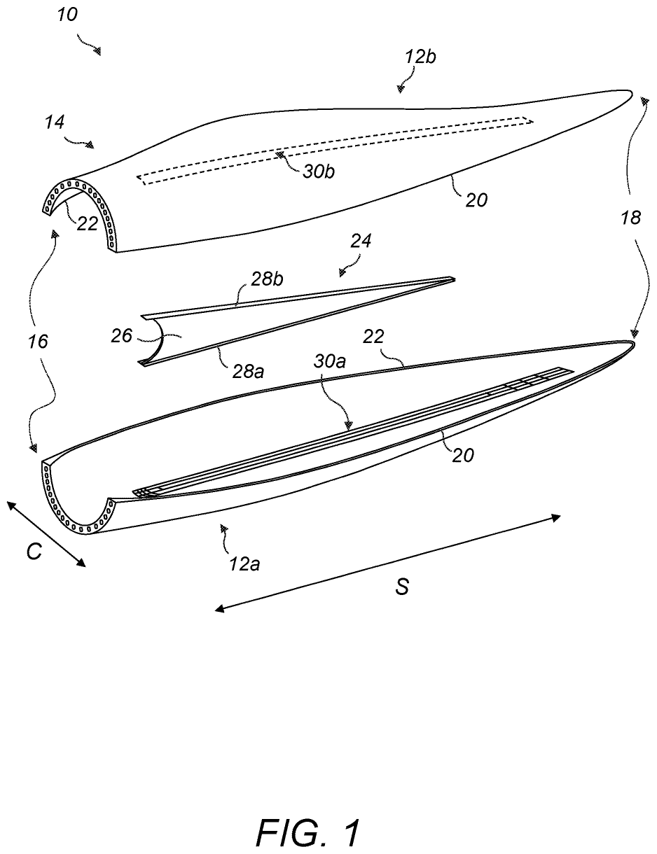

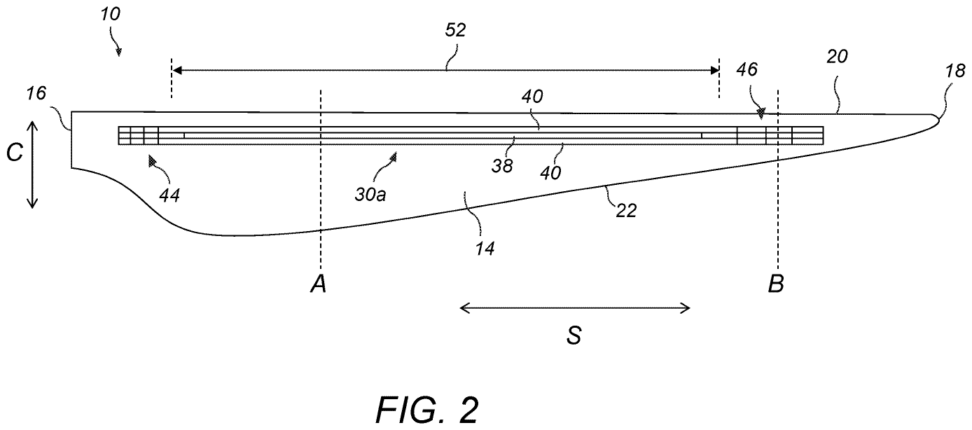

FIGS. 1 and 2 show a wind turbine blade 10 in a schematic exploded view and a schematic plan view. The blade 10 comprises a first half shell 12a and a second half shell 12b which are joined together to form a blade shell 14. The blade shell 14 extends longitudinally in a spanwise direction(S) from a root end 16 to a tip end 18 and transversely in a chordwise direction (C) between a leading edge 20 and a trailing edge 22. The blade shell 14 preferably defines an aerodynamic contour configured to capture energy from wind incident on the blade 10 in use.

The wind turbine blade 10 further comprises a shear web 24 configured to absorb and transfer shear loads experienced by the blade 10 in use. The shear web 24 comprises a longitudinally-extending web panel 26 and first and second mounting flanges 28a, 28b that extend transverse to the web panel 26 along respective longitudinal edges of the web panel 26. In some examples the first and second mounting flanges 28a, 28b may extend transverse to the web panel 26 on both a first side and a second side of the web panel 26 such that the shear web 24 resembles an I-beam, as shown in FIG. 1 for example.

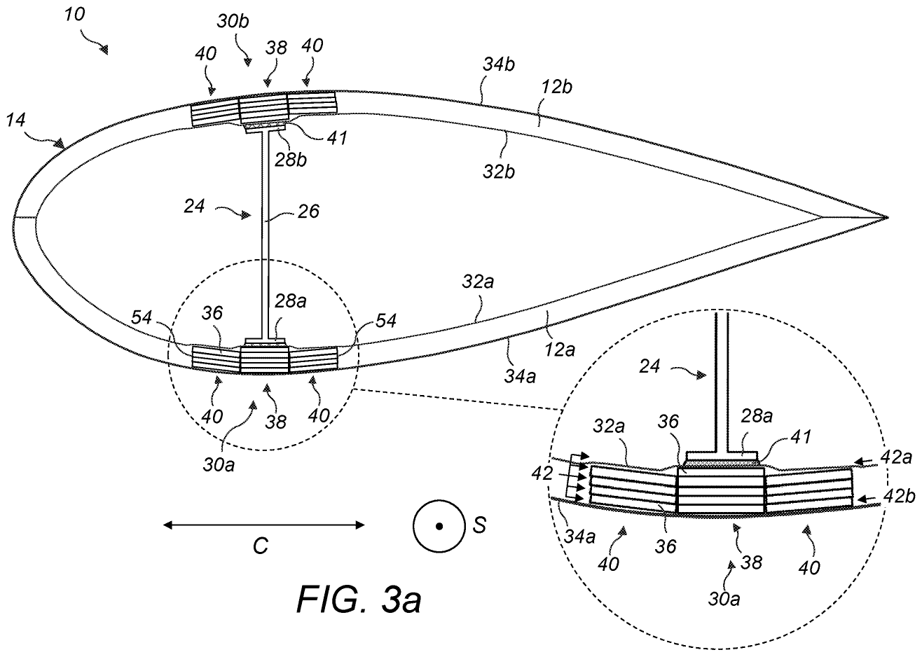

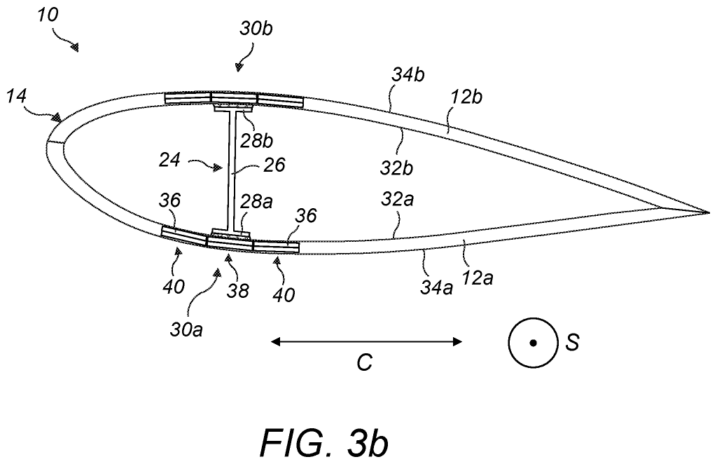

As will now be described in more detail with additional reference to the cross-sectional views shown in FIGS. 3a and 3b, the wind turbine blade 10 further comprises a first spar cap 30a and a second spar cap 30b. For reference, FIG. 3a shows a schematic cross-sectional view of a blade 10 taken at a first spanwise location A (indicated in FIG. 2) and FIG. 3b shows a second schematic cross-sectional view of the blade 10 taken at a second spanwise location B (also indicated in FIG. 2).

The first and second spar caps 30a, 30b are preferably integrated with the first and second half shells 12a, 12b. As such, the blade shell 14 may be referred to as a so-called structural shell. The opposing first and second half shells 12a, 12b are of composite laminate construction, and each half shell 12a, 12b therefore comprises an inner skin 32 on an inside of the blade shell 14 and an outer skin 34 on an outside of the blade shell 14. The first spar cap 30a is located between the inner and outer skins 32a, 34a of the first half shell 12a and the second spar cap 30b is located between the inner and outer skins 32b, 34b of the second half shell 12b.

Referring still to FIGS. 3a and 3b, the first spar cap 30a comprises strips of reinforcing material 36, such as carbon fibre reinforced plastic (CFRP) for example. The strips 36 are preferably substantially rectangular in transverse cross-section. For example, the strips 36 may have an aspect ratio, defined as the ratio of strip chordwise width to strip thickness, of at least 10:1 and preferably at least 20:1. For example, the strips 36 may have a chordwise width of approximately 200 mm and a thickness of approximately 5 mm resulting in an aspect ratio of 40:1. It will be appreciated that the schematic representations in the accompanying figures are not to scale, in particular the thickness of the strips 36 is exaggerated in the figures to show the strips 36 more clearly.

The strips 36 extend longitudinally in the spanwise direction(S) and are arranged in a plurality of side-by-side stacks 38, 40. The examples of FIGS. 3a and 3b show a first spar cap 30a comprising a single web-supporting stack 38 and two non-web-supporting stacks 40. However, as will be described later in more detail, in other examples the stacks 38, 40 may comprise one or more web-supporting stacks 38 and one or more non-web-supporting stacks 40.

As shown for example in FIGS. 3a and 3b, the first and second spar caps 30a, 30b are mutually opposed, and the shear web 24 is connected between the first and second spar caps 30a, 30b. The first mounting flange 28a of the shear web 24 is bonded to the inside of the first half shell 12a in the region of the web-supporting stack 38 of the first spar cap 30a, for example using an adhesive 41. The second mounting flange 28b is adhesively bonded to the inside of the second half shell 12b in the region of the second spar cap 30b. The mounting flanges 28a, 28b advantageously provide an increased surface area for bonding the shear web 24 to the inside of the first and second half shells 12a, 12b. Accordingly, the first and second mounting flanges 28a, 28b are preferably wider than the web panel 26 in the chordwise direction (C). This helps to safely distribute the loads transferred between the spar caps 30a, 30b and the shear web panel 26 in use, and also helps to stabilise the shear web 24.

The strips of reinforcing material 36 in the first spar cap 30a are arranged to provide the requisite structural reinforcement to the blade 10. Advantageously, the number of strips 36 in each stack 38, 40 may be different dependent on the structural reinforcement requirements for a particular portion of the blade 10. For example, as shown in FIG. 3a, at a first spanwise location A along the blade 10, the number of strips 36 in the web-supporting stack 38 of the first spar cap 30a is different to the number of strips 36 in the non-web-supporting stacks 40.

Referring still to FIG. 3a, in some examples, the web-supporting stack 38 of the first spar cap 30a may include a greater number of strips 36 than a non-web-supporting stack 40 at the first spanwise location A. Accordingly, the web-supporting stack 38 may provide additional structural reinforcement compared to the non-web-supporting stacks 40 at the first spanwise location A. In some other examples (not shown), the web-supporting stack 38 may comprise fewer strips 36 than the non-web-supporting stacks 40 at the first spanwise location A. In such an example, the non-web-supporting stacks 40 may provide more structural reinforcement than the web-supporting stack 38 at the first spanwise location A.

The difference in number of strips 36 in the stacks 38, 40 at the first spanwise location A may result in a height of the web-supporting stack 38 being different to a height of a non-web supporting stack 40. Accordingly, as shown in FIG. 3a, at the first spanwise location A the first spar cap 30a may vary in thickness across its full width in the chordwise direction (C).

Referring now to FIG. 3b, at a second spanwise location B along the blade 10 the number of strips 36 in the web-supporting stack 38 of the first spar cap 30a may be the same as the number of strips 36 in the non-web-supporting stacks 40. Accordingly, the first spar cap 30a may have a substantially constant thickness across its full chordwise width at the second spanwise location B.

As noted above, in accordance with the examples described herein, the arrangement of reinforcing material, i.e. the arrangement of the strips of reinforcing material 36, may be tailored to the structural reinforcement requirements of one or more specific portions of a blade 10. For example, with reference to the examples of FIGS. 3a and 3b, the configuration of the first spar cap 30a allows for the arrangement of more reinforcing material (strips 36) in the areas requiring additional reinforcement, without unnecessarily including additional reinforcing material where it is not required, thereby helping to minimise weight and cost of the blade 10. In particular, tailoring the amount of reinforcing material in each stack 38, 40, rather than across the whole width of the spar cap 30a, i.e. by varying the number of strips 36 in the web-supporting stacks 38 and non-web-supporting stacks 40 relative to one another at a given spanwise location, facilitates finer adjustment of the amount, and location, of the reinforcing material in the blade 10.

Referring still to the initial example in FIGS. 3a and 3b, and particularly the detail view in FIG. 3a, arranging the strips of reinforcing material 36 in side-by-side stacks 38, 40 may in some examples result in the strips 36 being arranged in a plurality of layers 42. With reference to the inner and outer skins 32a, 34a of the first half shell 12a, an innermost layer 42a refers to the layer of strips 36 that is adjacent, or closest, to the inner skin 32a, and an outermost layer 42b refers to the layer of strips 36 adjacent, or closest, to the outer skin 34a. The outermost layer 42b may comprise a greater number of strips 36 than the innermost layer 42a in some examples. Further still, in some preferred examples, each layer 42 of the first spar cap 30a may include the same number of strips 36, except for one or more innermost layers 42a which include fewer strips 36.

As previously described, in some examples the web-supporting stack 38 may include more strips of reinforcing material 36 than each non-web-supporting stack 40, i.e. the web-supporting stack 38 may include additional strips 36 compared to each non-web-supporting stack 40, as shown in FIG. 3a. Conversely, in some other examples (not shown) each non-web-supporting stack 40 may include more strips of reinforcing material 36 than the web-supporting stack 38, i.e. each non-web-supporting stack 40 may include additional strips 36 compared to the web-supporting stack 38. With reference to FIG. 3a, it will be appreciated that the “additional strips 36” in each example preferably form the innermost layer of strips 42a.

In preferred examples, the strips 36 forming the innermost layer 42a of the first spar cap 30a, i.e. the additional strips 36, may be strips exclusively within the web-supporting stack(s) 38, or in other examples the strips 36 forming the innermost layer 42a may be strips 36 exclusively within the non-web-supporting stacks 40. As such, the innermost layer of strips 42a is preferably formed of strips 36 within a single type of stack, either a web-supporting stack 38 or a non-web-supporting stack 40, dependent on the structural requirements of the blade 10.

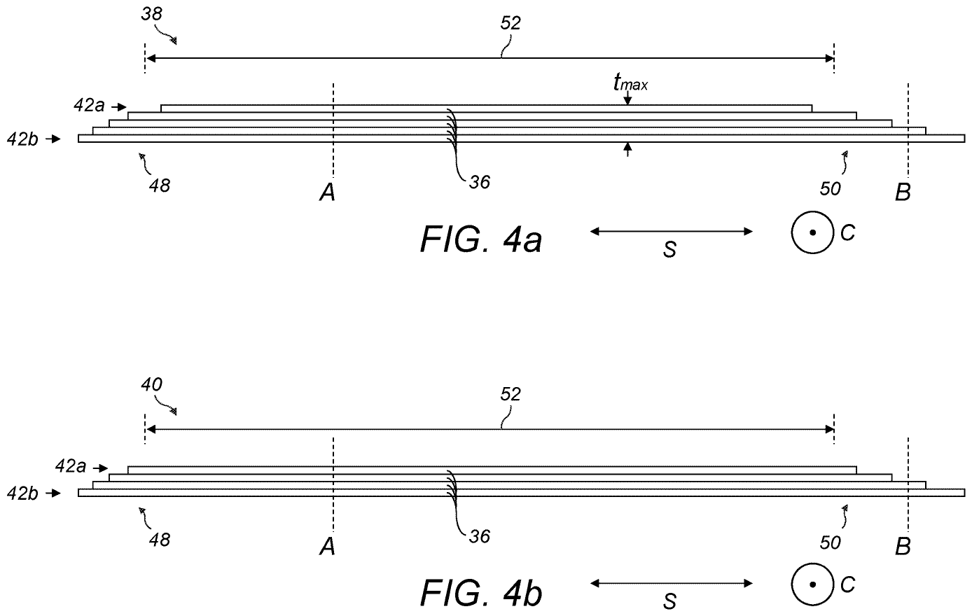

It will be appreciated that the or each strip 36 in a given layer 42 does not necessarily extend along the full length of the spar cap 30a. For example, the strips of reinforcing material 36 may vary in length between the different layers 42 in the first spar cap 30a. As shown for example in the side views of the stacks 38, 40 in FIGS. 4a and 4b, the strips of reinforcing material 36 in each innermost layer 42a may be shorter than the strips 36 in each outermost layer 42b of the respective stack 38, 40. Further still, in some examples the spar cap 30a may taper in thickness towards the root end 16 and/or towards the tip end 18 of the blade 10, i.e. the first spar cap 30a may comprise a tapered root end portion 44 and/or a tapered tip end portion 46 (shown in FIG. 2). In such examples, the strips 36 in each layer may become successively shorter going from the outermost layer 42b to the innermost layer 42a to form a tapered root end portion 48 and/or a tapered tip end portion 50 of the stack 38, 40. It will be appreciated that the side views in FIGS. 4a and 4b shows the stacks 38, 40 in isolation, and other features, such as the inner and outer skins 32, 34 and any core material of the composite half shell 12, are omitted for clarity. To provide more context to the first and second spanwise locations A, B, reference is made briefly to FIG. 2 in addition to FIGS. 4a and 4b. FIG. 4a is a side view of a web-supporting stack of strips of the first spar cap and FIG. 4b is a side view of a non-web-supporting stack of strips of the first spar cap. As indicated in these figures, the first spanwise location A is preferably in a central portion 52 of the blade 10. Conversely, the second spanwise location B may be between the tip end of the blade 18 and the central portion 52. Whilst not identified in the figures, in some other examples the second spanwise location B may be between the root end of the blade 16 and the central portion 52. In some examples, features described in relation to the second spanwise location B may be equally applicable both to spanwise locations between the root end 16 and the central portion 52, and to spanwise locations between the tip end 18 and the central portion 52.

In some examples, the central portion 52 may have a spanwise extent of between 10-40% of the overall length of the spar cap 30a. The first spar cap 30a may have a maximum thickness tmax in the central portion 52. In some examples, the first spar cap 30a may have a substantially constant maximum thickness tmax throughout the central portion 52. It will be appreciated that the tapered root end portion 44 and/or tapered tip end portion 46 of the first spar cap 30a may therefore be outside of the central portion 52 in some examples. Referring again to the first spar cap 30a shown in the examples of FIGS. 3a and 3b, the first spar cap 30a may include a web-supporting stack 38 defining a chordwise centre of the first spar cap 30a. Additionally, the spar cap 30a may include a non-web-supporting stack 40 on a leading-edge side of the web-supporting stack 38, and a non-web-supporting stack 40 on a trailing-edge side of the web-supporting stack 38. In such an arrangement, the non-web-supporting stacks 40 of the first spar cap 30a define longitudinal edges 54 of the first spar cap 30a. It will be appreciated that in some other examples (not shown) the spar cap 30a may comprise a plurality of web supporting stacks 38 defining a chordwise centre of the spar cap 30a and/or one or more non-web-supporting stacks 40 on each of the leading edge or trailing edge side of the web-supporting stack(s) 38.

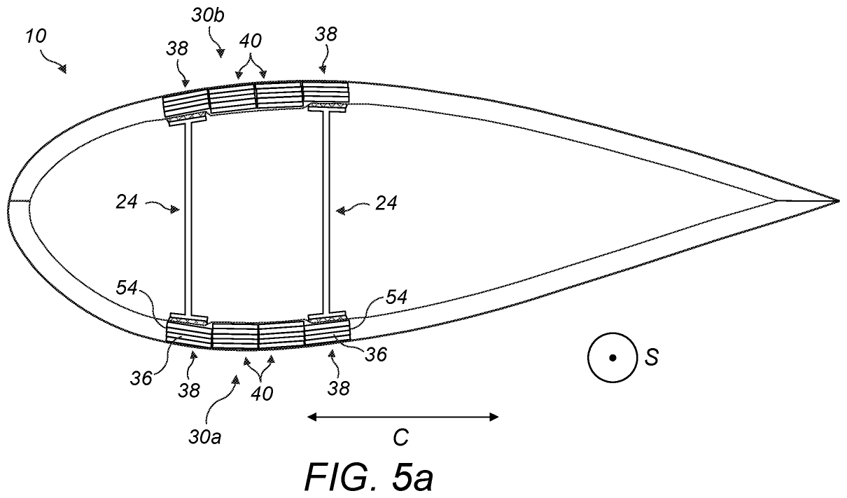

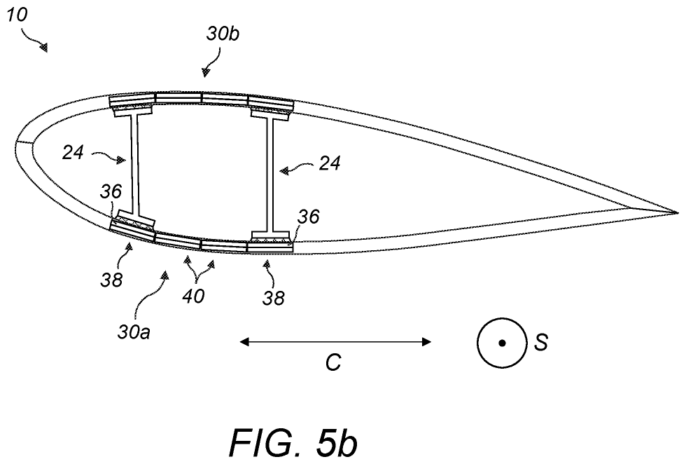

The schematic cross-sectional views in FIGS. 5a and 5b show a further configuration of the stacks 38, 40 in the first spar cap 30a in another example. FIGS. 5a and 5b show transverse cross-sections taken at the first spanwise location A and the second spanwise location B of a wind turbine blade 10 that is similar to the blade 10 described previously with reference to FIGS. 1 to 4b.

The blade shown in the example of FIGS. 5a and 5b comprises a second shear web 24 in addition to the first shear web 24. It will be appreciated that the blade 10 represented in FIGS. 5a and 5b has the same features described previously with reference to the preceding figures, except for the inclusion of a second shear web 24 and the arrangement of the stacks of strips 38, 40 forming the first spar cap 30a. The second shear web 24 is configured in substantially the same way as the previously-described first shear web 24 and will therefore not be described in any further detail. Similarly, other equivalent features will not be described again to avoid repetition.

As shown in FIGS. 5a and 5b, in some examples the first spar cap 30a may include a first web-supporting stack 38 supporting the first shear web 24 and a second web-supporting stack 38 supporting the second shear web 24. Additionally, the first spar cap 30a may include one or more non-web-supporting stacks 40 arranged between the first and second web-supporting stacks 38. Accordingly, in such an arrangement the web-supporting-stacks 38 may define the longitudinal edges 54 of the first spar cap 30a. The spar caps 30a, 30b and shear webs 24 in such an example may advantageously form a box spar structure that provides increased rigidity and structural reinforcement to the blade shell 14.

In the same way as previously described with reference to the examples in FIGS. 2 to 4b, at the first spanwise location A, the number of strips 36 in the web-supporting stacks 38 of the first spar cap 30a is different to the number of strips 36 in the or each non-web-supporting stack 40. Again, similar to the examples described previously, at the second spanwise location B, shown in FIG. 5b for example, the number of strips 36 in the web supporting stacks 38 is preferably the same as the number of strips 36 in the non-web-supporting stacks 40.

It will be appreciated that the examples described above each include a single web-supporting stack 38 supporting the or each shear web 24. However, as noted briefly above, in some examples (not shown) the or each shear web 24 may be supported by a plurality of web-supporting stacks 38. Such a configuration may help the stacks 38, 40 of the first spar cap 30a conform to the contour of the blade shell 14.

It should be understood that the description provided above with reference to examples wherein the or each shear web 24 is supported by a single web-supporting stack 38 is equally applicable to examples wherein the or each shear web 24 is supported by a plurality of web-supporting stacks 38. For example, in relation to the description provided with reference to FIGS. 2 to 4b, it should be understood that references to “the” web-supporting stack 38 could equally be references to “the or each” web-supporting stack in some examples. Further, in relation to the description provided with reference to the examples of FIGS. 5a and 5b, it should be understood that references to “a” or “the” first web-supporting stack 38 and “a” or “the” second web-supporting stack 38 could equally be references to “the or each” first web-supporting stack(s) 38 and “the or each” second web-supporting stack(s) 38.

Further, whilst not shown in the example of FIGS. 5a and 5b, in examples where the first spar cap 30a comprises one or more first web-supporting stack(s) 38 supporting a first shear web 24 and one or more second web-supporting stack(s) 38 supporting a second shear web 24, the spar cap 30a may further comprise one or more non-web-supporting 40 stacks on a leading-edge side of the first web-supporting stack 38 and one or more non-web-supporting stacks 40 on a trailing edge side of the second web-supporting stack 38. Such non-web-supporting stacks 40 may define the longitudinal edges 54 of the spar cap 30a in such an example.

Finally, whilst the first spar cap 30a has been described in detail, it will be appreciated that in some examples the second spar cap 30b of a blade 10 may comprise web-supporting and non-web-supporting stacks 38, 40 arranged in a similar manner to the examples of the first spar cap 30a described above. It should be noted that in such examples, the arrangement of stacks 38, 40 for the second spar cap 30b may not necessarily be exactly the same as the first spar cap 30a. For example, different sides of the blade 10, i.e. the windward side and the leeward side, may experience different loading in use. As such, one of the first or second spar caps 30a, 30b may be configured with more structural reinforcement than the other spar cap 30a, 30b, to handle the higher loading in use.

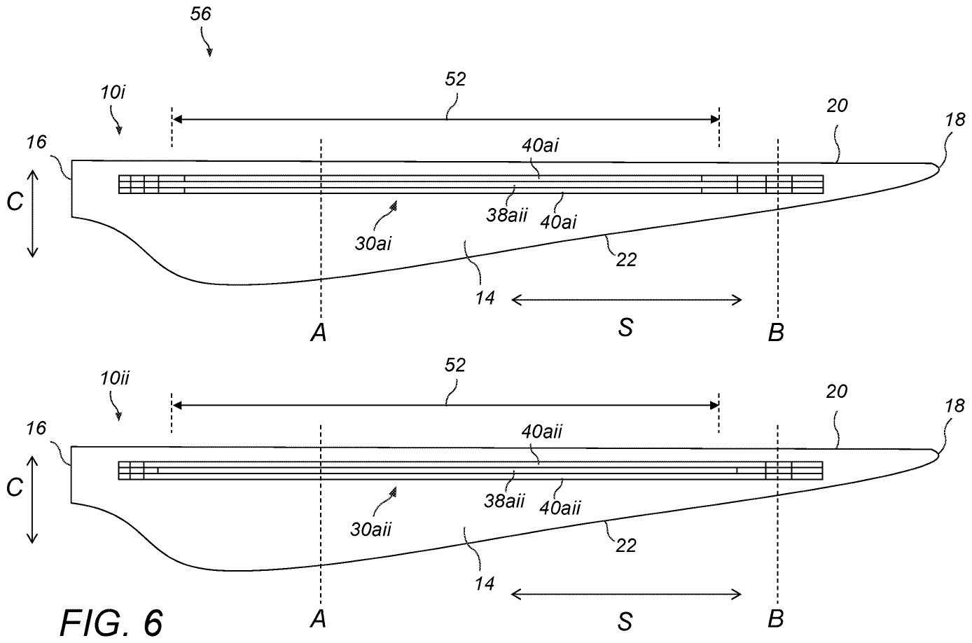

FIG. 6 shows a first wind turbine blade 10i and a second wind turbine blade 10ii which are part of a family of wind turbine blades 56 of substantially equal length and of substantially the same external shape. The first blade 10i is designed for a first wind turbine operating in a first wind class and/or having a first rated power, whereas the second blade 10ii is designed for a second wind turbine operating in a second wind class and/or having a second rated power. The first and second wind classes and/or rated powers are different, and the structural reinforcement requirements of the first and second blades 10i, 10ii are therefore also different, as mentioned previously by way of background.

In some examples, the first and/or second wind turbine blades 10i, 10ii in the family 56 may be blades such as those described previously with reference to the examples of FIGS. 1 to 5b. As such, features of the blades 10 described previously with reference to the examples of FIGS. 1 to 5b may be equally applicable to the first and second blades 10i, 10ii of the family 56 shown in FIGS. 6 to 8b, in some examples. It will be appreciated that equivalent features will not be described in detail again to avoid repetition. The first and second blades 10i, 10ii will now be described with reference to FIGS. 6 to 8b.

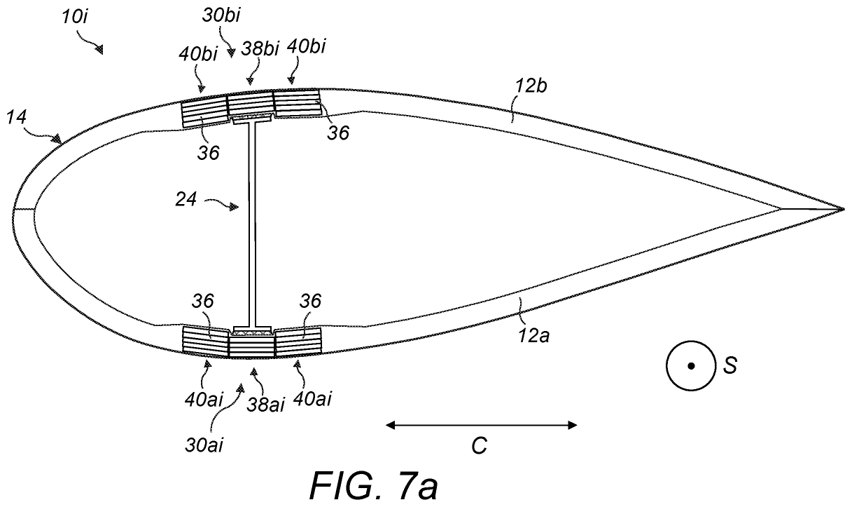

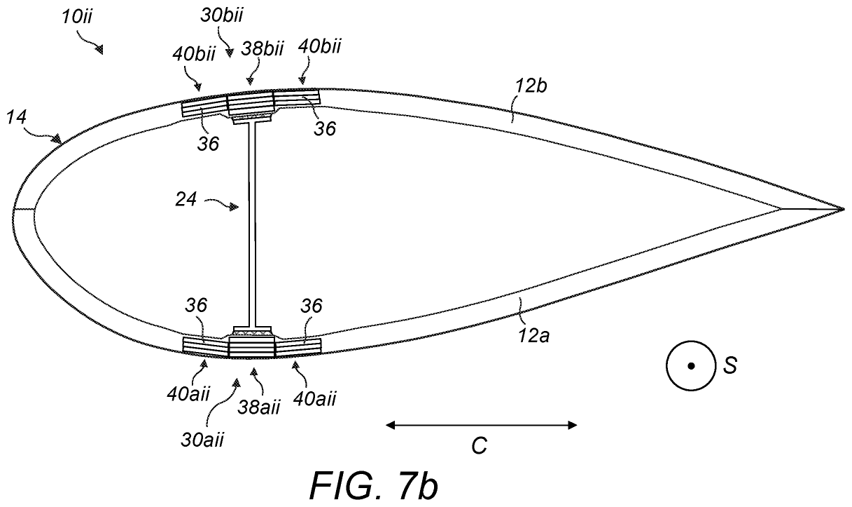

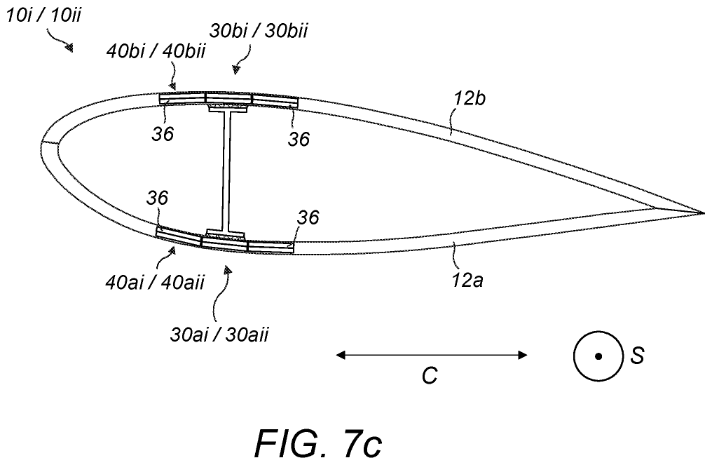

For the avoidance of doubt, the first and second wind turbine blades 10i, 10ii each comprise a blade shell 14 that extends longitudinally in a spanwise direction(S) from a root end 16 to a tip end 18 and transversely in a chordwise direction (C) between a leading edge 20 and a trailing edge 22. As shown most clearly in the schematic cross-sectional views of FIGS. 7a to 7c, the blade shell 14 of each blade 10i, 10ii is formed from first and second opposing half shells 12a, 12b.

Further, the first and second blades 10i, 10ii each comprise a first spar cap 30a associated with the first half shell 12a and a second spar cap 30b associated with the second half shell 12b. As described previously with reference to the examples of FIGS. 1 to 5b, the first spar cap 30a comprises a plurality of side-by-side stacks 38, 40 of longitudinally-extending strips of reinforcing material 36, and the stacks include at least one web-supporting stack 38 and at least one non-web-supporting stack 40.

In preferred examples, and as shown in FIGS. 7a and 7b for example, the corresponding first spar caps, 30ai, 30aii of the first and second blades 10i, 10ii in the family 56 have the same number of stacks 38, 40. In particular, the corresponding spar caps 30ai, 30aii preferably each have the same number of web-supporting stacks 38. In the example shown in FIGS. 7a and 7b the corresponding first spar caps 30a, 30aii each have three side-by-side stacks 38, 40, and each has a single web-supporting stack. It follows that the corresponding first spar caps 30ai, 30aii preferably have the same dimension (width) in the chordwise direction (C).

However, as mentioned previously, the structural reinforcement requirements of the first and second blades 10i, 10ii may be different, despite the blades being of substantially equal length and substantially the same external shape. Accordingly, the first spar cap 30ai of the first blade 10i is configured differently to the first spar cap 30aii of the second blade 10ii. As shown in the cross-sectional views of FIGS. 7a and 7b, at the first spanwise location A, the number of strips 36 in a non-web-supporting stack 40ai of the first spar cap 30a of the first blade 10i is different to the number of strips 36 in a corresponding non-web-supporting stack 40aii of the first spar cap 30aii of the second blade 10ii.

For example, the first blade 10i may be designed for a wind turbine operating in a higher wind class, and as such, the non-web-supporting stacks 40ai of the first spar cap 30ai of the first blade 10i may have more strips 36 at the first spanwise location A than the corresponding non-web-supporting stacks 40aii of the first spar cap 30aii of the second blade 10ii. This may result in the non-web-supporting stacks 40ai of the first blade 10i having a greater stack height than the corresponding non-web-supporting stacks 40aii of the second blade 10ii. The additional strips 36 in the first spar cap 30ai of the first blade 10i may provide more structural reinforcement such that the first blade 10i can operate safely in higher wind conditions than the second blade 10ii.

In preferred examples, the second spar cap 30bi, 30bii of the first and second blades 10i, 10ii may also comprise a plurality of side-by-side stacks 38, 40 of longitudinally-extending strips of reinforcing material 36. The second spar cap 30bi, 30bii of each blade 10i, 10ii may be configured in a substantially similar manner, but not necessarily exactly the same, to the first spar cap 30ai, 30aii and will therefore not be described in detail to avoid repetition. As shown in FIGS. 7a and 7b, each blade 10i, 10ii in the family 56 further comprises a shear web 24 connected between the mutually opposed first and second spar caps 30ai, 30bi and 30aii, 30bii, for example between mutually opposed web-supporting stacks 38ai, 38bi and 38aii, 38bii. As will now be described, in some advantageous examples the shear web 24 of the first blade 10i may be substantially the same as the shear web 24 of the second blade 10ii.

In some examples, along the length of the first and second spar caps 30a, 30b, a separation between the web-supporting stacks 38ai, 38bi of the first and second spar caps 30ai, 30bi of the first blade 10i may be substantially the same as a separation between the web-supporting stacks 38aii, 38bii of the first and second spar caps 30aii, 30bii of the second blade 10ii. This means that the same shear web design and tooling can be used for the shear webs 24 of both the first and second blade 10i, 10ii, despite the blades and their spar caps 30ai, 30bi, 30aii, 30bii being designed and manufactured for different structural reinforcement requirements. In some examples this could substantially reduce the time and cost of developing and manufacturing different blades 10i, 10ii within a blade family 56 for different operating conditions.

In order to provide the requisite structural reinforcement to the first and second blade 10i, 10ii, the corresponding non-web-supporting stacks 40 of each blade have different numbers of strips of reinforcing material 36, as previously described. This means that in some examples, along at least a portion of the length of the spar caps 30ai, 30bi, 30aii, 30bii, a separation between the non-web-supporting stacks 40ai, 40bi of the first and second spar caps 30ai, 30bi of the first blade 10i may be different to a separation between the corresponding non-web-supporting stacks 40aii, 40bii of the first and second spar caps 30aii, 30bii of the second blade 10ii. FIGS. 7a and 7b show an example of this difference in separation at the first spanwise location A.

The configuration of the or each non-web-supporting stack 40ai, 40aii of the first spar cap 30ai, 30aii of the first and second blades 10i, 10ii is tailored to the structural requirements of the respective blade. As such, in some portions of the blades 10i, 10ii there is a difference in the number of strips 36 in the corresponding non-web-supporting stacks 40ai, 40aii. However, in other portions of the blade 10i, 10ii, the structural requirements may be substantially the same for both blades. For example, FIG. 7c shows a schematic cross-sectional view of the second spanwise location B of both the first and second blades 10i, 10ii of the family 56. As seen in this example, at the second spanwise location B, the number of strips 36 in the or each non-web-supporting stack 40ai of the first spar cap 30ai of the first blade 10i may be the same as the number of strips 36 in the or each corresponding non-web-supporting stack 40aii of the first spar cap 30aii of the second blade 10ii.

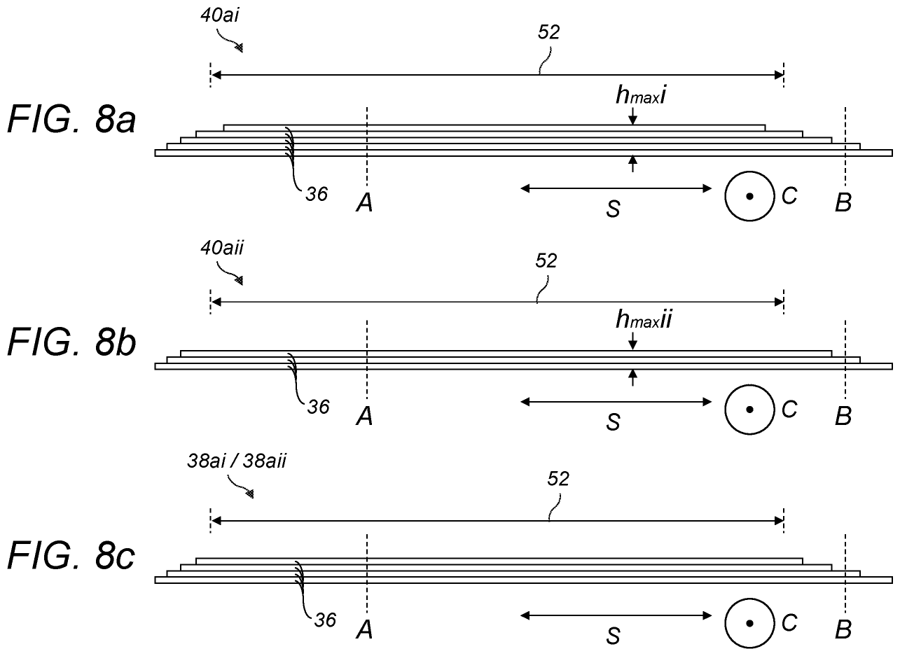

As previously described with reference to the examples of FIGS. 1 to 5b, the first spanwise location A may be in a central portion 52 of the blade 10i, 10ii. The spanwise location A and central portion 52 are indicated in the side views of FIGS. 8a to 8c. FIG. 8a shows a side view of a non-web-supporting stack 40ai of the first blade 10i, FIG. 8b shows a side view of a non-web-supporting stack 40aii of the second blade 10ii, and FIG. 8c shows the web-supporting stack 38ai / 38aii of the first and second blades 10i, 10ii.

Referring to FIGS. 8a and 8b, the or each non-web-supporting stack 40ai of the first blade 10i may have a different height to the non-web-supporting stack 40aii of the second blade 10ii throughout the central portion 52. Outside of the central portion 52, i.e. excluding the central portion 52, the corresponding non-web-supporting stacks 40ai, 40aii of the first and second blades 10i, 10ii may be substantially the same.

Still with reference to FIGS. 8a and 8b, the corresponding non-web-supporting stacks 40ai, 40aii of the first and second blades 10i, 10ii may each comprise a portion where the stack is a maximum height hmaxi, hmaxii, and each stack may taper from the maximum height towards the respective root and tip end 16, 18 of the blade 10, 10ii. As shown by a comparison of FIGS. 8a and 8b, the portion of maximum stack height hmaxi for the non-web-supporting stack 40ai of the first blade 10i may be offset in the spanwise direction(S) compared to the portion of maximum stack height hmaxii for the corresponding non-web-supporting stack 40aii of the second blade 10ii. This is because, as previously described, the strips 36 of the non-web-supporting stacks 40ai, 40aii in different blades 10i, 10ii of the family 56 may be arranged differently to provide structural reinforcement in different specific portions of each blade 10i, 10ii as required. Further, as previously described, the web-supporting stack(s) 38ai, 38aii of each blade 10i, 10ii may be arranged in substantially the same configuration, as shown in FIG. 8c, facilitating the use of the same shear web 24 in each blade 10i, 10ii.

For reference, it will be appreciated that the side views in FIGS. 8a, 8b and 8c show the stacks 40ai, 40aii, 38ai/38aii in isolation, and other features, such as inner and outer skins and any core material of the composite half shells, are omitted for clarity.

The configurations of the first spar caps 30ai, 30aii of the first and second blades 10i, 10ii of the family 56 shown in FIGS. 6 to 8b are provided by way of example only. In particular, the layout of the stacks 38, 40 in the examples shown in FIGS. 7a and 7b is substantially similar to the layout previously described with reference to the example of FIGS. 3a and 3b. However, it will be appreciated that other stack layouts, such as those described with reference to FIGS. 5a and 5b and other optional configurations described with reference to FIGS. 1 to 5b, may be equally applicable to blades in the family of wind turbine blades 56, such as the first and second blades 10i, 10ii shown in FIGS. 6 to 8b. Additionally, it will be appreciated that whilst the description of FIGS. 6 to 8b is focussed primarily on the first spar caps 30ai, 30aii, of the first and second blades 10i, 10ii in a similar manner to the description of FIGS. 1 to 5b any description provided herein with reference to the first spar caps 30ai, 30aii may be equally applicable to the second spar caps 30bi, 30bii in some examples.

Finally, it will be appreciated that the description provided above serves to demonstrate a plurality of possible examples of the present invention. Features described in relation to any of the examples above may be readily combined with any other features described with reference to different examples without departing from the scope of the invention as defined in the appended claims.

1. A wind turbine blade comprising:
a blade shell that extends longitudinally in a spanwise direction from a root end to a tip end, and transversely in a chordwise direction between a leading edge and a trailing edge, the blade shell being formed from first and second opposing half shells of composite laminate construction;
each half shell comprising an inner skin on an inside of the blade shell and an outer skin on an outside of the blade shell;
a first spar cap located between the inner and outer skins of the first half shell and a second spar cap located between the inner and outer skins of the second half shell, the first and second spar caps being mutually opposed;
wherein the first spar cap comprises a plurality of side-by-side stacks of longitudinally-extending strips of reinforcing material, the stacks including at least one web-supporting stack and at least one non-web-supporting stack;
a shear web connected between the first and second spar caps, the shear web comprising a longitudinally-extending web panel and first and second mounting flanges, the first and second mounting flanges extending transversely to the web panel along respective longitudinal edges of the web panel, the first mounting flange being adhesively bonded to the inside of the first half shell in the region of the web-supporting stack(s) of the first spar cap and the second mounting flange being adhesively bonded to the inside of the second half shell in the region of the second spar cap;
wherein, at a first spanwise location along the blade, the number of strips in a web-supporting stack of the first spar cap is different to the number of strips in a non-web-supporting stack of the first spar cap.

2. The wind turbine blade of claim 1, wherein at the first spanwise location, a height of a web-supporting stack of the first spar cap is different to a height of a non-web-supporting stack.

3. The wind turbine blade of claim 1, wherein at the first spanwise location, a web-supporting stack of the first spar cap includes a greater number of strips than a non-web-supporting stack.

4. The wind turbine blade of claim 1 wherein at the first spanwise location, a web-supporting stack of the first spar cap includes fewer strips than a non-web-supporting stack.

5. The wind turbine blade of claim 1, wherein at a second spanwise location along the blade, the number of strips in a web-supporting stack of the first spar cap is the same as the number of strips in a non-web-supporting stack.

6. The wind turbine blade of claim 5, wherein the first spanwise location is in a central portion of the blade and the second spanwise location is between the root end of the blade and the central portion and/or between the tip end of the blade and the central portion.

7. The wind turbine blade of claim 6, wherein the central portion has a spanwise extent of between 10-40% of the overall length of the first spar cap.

8. The wind turbine blade of claim 6, wherein the first spar cap has a maximum thickness throughout the central portion of the blade and tapers in thickness outside of the central portion towards the root end and/or towards the tip end of the blade.

9. The wind turbine blade of claim 5, wherein the first spar cap has a substantially constant thickness across its full width in the chordwise direction at the second spanwise location.

10. The wind turbine blade of claim 1, wherein the first spar cap varies in thickness across its full width in the chordwise direction at the first spanwise location.

11. The wind turbine blade of claim 1, wherein the strips forming the first spar cap are arranged in a plurality of layers, and wherein the number of strips in an outermost layer adjacent the outer skin is greater than the number of strips in an innermost layer.

12. The spar cap of claim 11, wherein the strips in the innermost layer are shorter than the strips in the outermost layer.

13. The wind turbine blade of claim 11, wherein the innermost layer of strips in the first spar cap consists exclusively of strips within web-supporting stacks or consists exclusively of strips within non-web-supporting stacks.

14. The wind turbine blade of claim 11, wherein each layer of the first spar cap includes the same number of strips except for one or more innermost layers, which include fewer strips and those strips are exclusively within web-supporting stacks or non-web-supporting stacks.

15. The wind turbine blade of claim 1, wherein the first spar cap includes one or more web-supporting stacks defining a chordwise centre of the first spar cap; one or more first non-web-supporting stacks on a leading-edge side of the web-supporting stack(s); and one or more second non-web-supporting stacks on a trailing-edge side of the web-supporting stack(s).

16. The wind turbine blade of claim 15, wherein the non-web-supporting stacks of the first spar cap define longitudinal edges of the first spar cap.

17. The wind turbine blade of claim 1, wherein the first spar cap includes one or more first web-supporting stacks supporting a first shear web; one or more second web-supporting stacks supporting a second shear web; and
one or more non-web-supporting stacks arranged between the first and second web-supporting stacks.

18. The wind turbine blade of claim 17, wherein the web-supporting-stacks of the first spar cap define longitudinal edges of the first spar cap.

19. The wind turbine blade of claim 1, wherein the first and second mounting flanges of the shear web are wider than the web panel in the chordwise direction.

20. The wind turbine blade of claim 1, wherein the strips of reinforcing material have an aspect ratio of at least 10:1, where the aspect ratio is defined as the ratio of the width of the strips in the chordwise direction to the thickness of the strips.
